(19) United States
(12) Patent Application Publication
(10) Pub. No.: US 2024/0040562 A1
(43) Pub. Date: Feb. 1, 2024

(54) Best Effort Up Link (UL) Fractional Frequency Reuse (FFR)

(71) Applicant: Parallel Wireless, Inc., Nashua, NH (US)

(72) Inventor: Nimrod Gradus, Givatayim (IL)

(21) Appl. No.: 18/358,020

(22) Filed: Jul. 24, 2023

Related U.S. Application Data
(60) Provisional application No. 63/391,383, filed on Jul. 22, 2022.

(51) Int. Cl. H04W 72/1268; H04W 72/566; H04W 72/0453

(52) U.S. Cl. CPC H04W 72/1268; H04W 72/566; H04W 72/0453

(57) ABSTRACT

This invention relates to an efficient and simple best effort UL FFR, describing how to effectively partition the bandwidth (BW) into regions and how to allocate different UEs into those partitions. In one embodiment, a method of Uplink (UL) Fractional Frequency Reuse (FFR) includes classifying a User Equipment (UE) as either a cell-edge UE or a cell-center UE; examining each UE before each UL scheduling and updating a status of the UE that was examiner; and choosing a cell-edge segment for each cell, a cell-edge segment including a starting SB index and an end SB index, wherein an SB is a group of Resource Blocks (RBs), wherein the cell edge segment is defined using the physical cell indicator (PCI) as an input.

### CROSS-REFERENCE TO RELATED APPLICATIONS

The present application claims priority under 37 CFR § 119(e) to U.S. Provisional Patent Application No. 63/391,383, which is also hereby incorporated by reference in its entirety. In addition, the present application hereby incorporates by reference, for all purposes, each of the following U.S. patent application Publications in their entirety: US20170013513A1; US20170026845A1; US20170055186A1; US20170070436A1; US20170077979A1; US20170019375A1; US20170111482A1; US20170048710A1; US20170127409A1; US20170064621A1; US20170202006A1; US20170238278A1; US20170171828A1; US20170181119A1; US20170273134A1; US20170272330A1; US20170208560A1; US20170288813A1; US20170295510A1; US20170303163A1; US20170257133A1; US20170202006A1. This application also hereby incorporates by reference U.S. Pat. No. 8,879,416, “Heterogeneous Mesh Network and Multi-RAT Node Used Therein,” filed May 8, 2013; U.S. Pat. No. 9,113,352, “Heterogeneous Self-Organizing Network for Access and Backhaul,” filed Sep. 12, 2013; U.S. Pat. No. 8,867,418, “Methods of Incorporating an Ad Hoc Cellular Network Into a Fixed Cellular Network,” filed Feb. 18, 2014; U.S. patent application Ser. No. 14/034,915, “Dynamic Multi-Access Wireless Network Virtualization,” filed Sep. 24, 2013; U.S. patent application Ser. No. 14/289,821, “Method of Connecting Security Gateway to Mesh Network,” filed May 29, 2014; U.S. patent application Ser. No. 14/500,989, “Adjusting Transmit Power Across a Network,” filed Sep. 29, 2014; U.S. patent application Ser. No. 14/506,587, “Multicast and Broadcast Services Over a Mesh Network,” filed Oct. 3, 2014; U.S. patent application Ser. No. 14/510,074, “Parameter Optimization and Event Prediction Based on Cell Heuristics,” filed Oct. 8, 2014, U.S. patent application Ser. No. 14/642,544, “Federated X2 Gateway,” filed Mar. 9, 2015, and U.S. patent application Ser. No. 14/936,267, “Self-Calibrating and Self-Adjusting Network,” filed Nov. 9, 2015; U.S. patent application Ser. No. 15/607,425, “End-to-End Prioritization for Mobile Base Station,” filed May 26, 2017; U.S. patent application Ser. No. 15/803,737, “Traffic Shaping and End-to-End Prioritization,” filed Nov. 27, 2017, each in its entirety for all purposes, having attorney docket numbers PWS-71700US01, US02, US03, 71710US01, 71721US01, 71729US01, 71730US01, 71731US01, 71756US01, 71775US01, 71865US01, and 71866US01, respectively. This document also hereby incorporates by reference U.S. Pat. Nos. 9,107,092, 8,867,418, and 9,232,547 in their entirety. This document also hereby incorporates by reference U.S. patent application Ser. No. 14/822,839, U.S. patent application Ser. No. 15/828,427, U.S. Pat. App. Pub. Nos. US20170273134A1, US20170127409A1 in their entirety.

### BACKGROUND

Improvement of cell coverage and network capacity are two major challenges for the 4G, and 5G cellular wireless communication networks. In this context, a limiting factor of system performance at cell-edge is inter-cell interference (ICI), and therefore, interference mitigation techniques must be considered. Fractional Frequency Reuse (FFR) is a well-known and efficient interference mitigation method in which a cell is divided into an inner and outer region, applying different frequencies allocation segments for each region, reducing ICI.

### SUMMARY

This invention relates to an efficient and simple best effort UL FFR, describing how to effectively partition the bandwidth (BW) into regions and how to allocate different UEs into those partitions. In one embodiment, a method of Uplink (UL) Fractional Frequency Reuse (FFR) includes classifying a User Equipment (UE) as either a cell-edge UE or a cell-center UE; examining each UE before each UL scheduling and updating a status of the UE that was examiner; and choosing a cell-edge segment for each cell, a cell-edge segment including a starting SB index and an end SB index, wherein an SB is a group of Resource Blocks (RBs), wherein the cell edge segment is defined using the physical cell indicator (PCI) as an input.

### BRIEF DESCRIPTION OF THE DRAWINGS

FIG. 1A depicts a cell edge between two cells, according to the prior art.

FIG. 1B depicts a series of steps for an efficient and simple best effort UL FFR, in accordance with some embodiments.

FIG. 2 is a schematic network architecture diagram for 3G and other-G prior art networks, in accordance with some embodiments.

FIG. 3 is an enhanced eNodeB for performing the methods described herein, in accordance with some embodiments.

FIG. 4 is a coordinating server for providing services and performing methods as described herein, in accordance with some embodiments.

FIG. 5 is a schematic diagram of another, multi-RAT OpenRAN-compliant deployment architecture, in accordance with some embodiments.

### DETAILED DESCRIPTION

In many dense LTE deployments, neighboring LTE cells are creating interference in both UL (by adjacent UEs connected to different cells) and in DL (by neighboring cells).

UL interference is caused by UEs located at cell edge conditions of neighboring cells, yet located adjacent to each other. In this situation, each cell may allocate overlapping resources (RBs) to the adjacent UEs, which in turn interfere with each other. One solution to such a problem is that the cell edge users of different neighboring cells are allocated with different starting indexes of frequency-domain resources to minimize such interference, this is called Fractional Frequency Reuse (FFR). In this invention, we shall formalize how each cell classifies UEs to cell-edge and cell-center UEs and decide on a different starting RB index for cell-edge users.

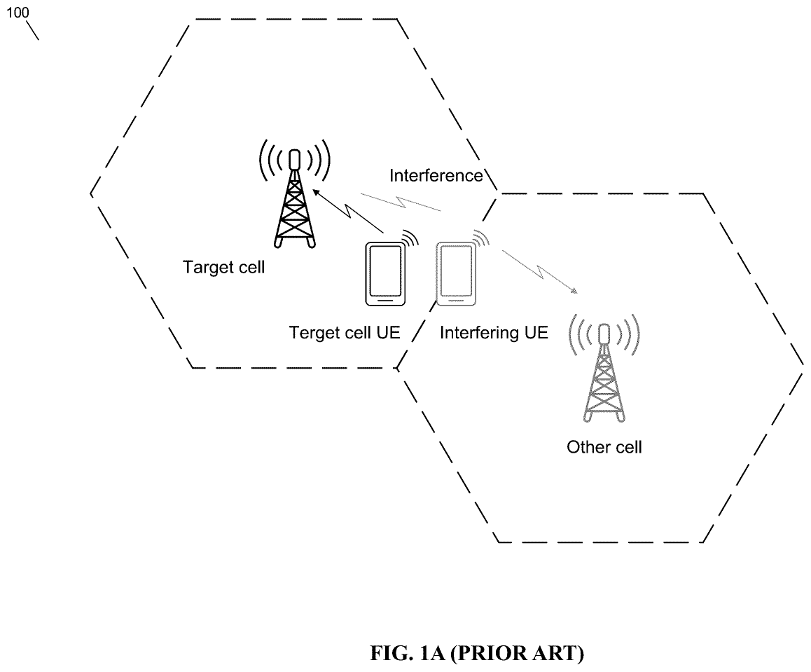

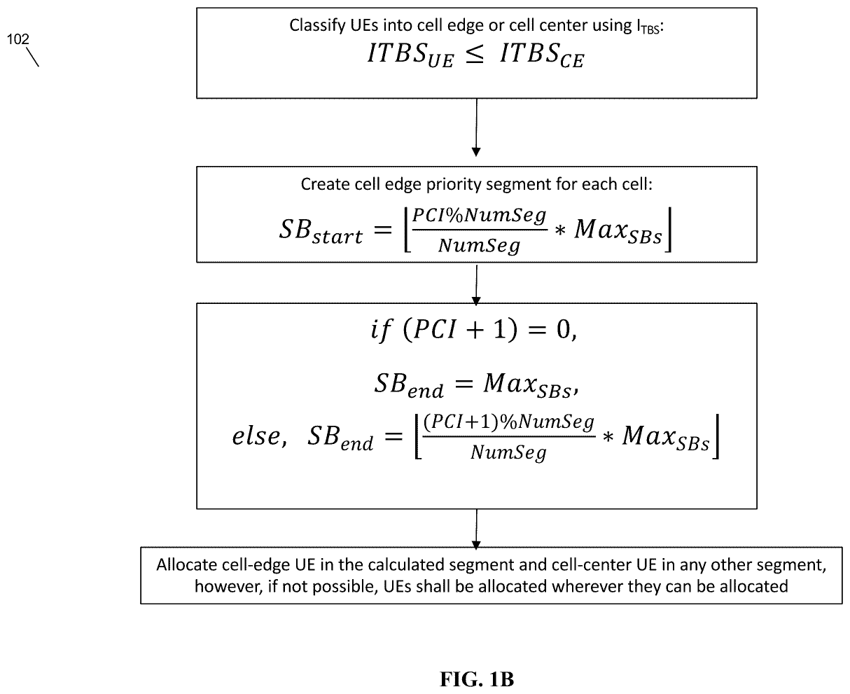

In a scenario commonly referred to as Soft Frequency Reuse, one such portion is used in a particular cell, and other cells may still use said portion but at limited RF power. Typically, a portion of the frequency is allocated to cell edge users in one cell and reused in neighboring cells for cell center users at a lower power. Since cell center users are close to the transmitting station, the power-restricted portion of the frequency can be effectively used to serve such users even while transmitting at a reduced power level. FIG. 1 shows examples of soft frequency reuse.

When the reservation of such frequency resources changes with time, we have dynamic FFR as opposed to static FFR where reservations are set up for long periods of time. This application describes at least a Dynamic Soft FFR scheme below.

In some embodiments, interfering cells may be called aggressors, and the cells being interfered with may be called victim cells. A user equipment (UE) that causes interference may be called an aggressor, and a UE that is subject to interference may be called a victim.

In some embodiments described below, the term “cell edge user” is understood more generally to mean a user that is experiencing interference above a certain threshold, not a user that is necessarily located in any particular physical coverage zone, and the term “cell center user” is understood to mean a user that is experiencing interference only below the certain threshold. Fractional frequency reuse (FFR) methods are described herein that use this definition of cell edge user and cell center user. FFR refers to the re-use of only a fraction (f<1) of the total available frequencies, hence the name.

When the interfering resources are forbidden from being used in the neighboring cells, we have Hard Fractional Frequency Reuse. When such frequency resources are used in neighbor cells in a manner that does not cause degrading interference to the said UEs, we have Soft Frequency Reuse. In a typical scenario, a UE is attached to and receives data from one base station (which is the aggressor node), which generates interference on the downlink band for UEs attached to one or more neighboring base stations (victim nodes). Interference commonly occurs at the cell edge, not at the cell center, because at the cell center, the reduced distance to the base station provides a greater signal to noise ratio. It follows that the frequencies and time slots associated with the cell center are readily able to be reused, while frequencies and time slots associated with the cell edge are not reused but instead are reserved.

FIG. 1A depicts a cell edge between two cells, according to the prior art. As mentioned, and depicted in FIG. 1A, the “target cell” and “Other cell” shall need to classify the “target cell” and “interfering” UE into cell edge UEs and decide on a different starting RB index for UL allocation for both of such UEs. We shall tackle such a problem without the need for any signaling between the two cells and suggest a simple solution that shall mitigate the UL interferences between the two UEs.

We first deal with the problem of classification of UEs into cell-edge and cell-center UEs. Such a problem is solved by examining the UE's downlink Transport Block Size Index (I_{TBS}), which is periodically updated by the Downlink Link Adaptation process with respect to the UE's path loss and channel condition. The UE's ITBS is an appropriate measurement of the UE's distance from the cell and therefore, a UE shall be classified as a cell-edge UE as follows,

ITBS_{UE}≤ITBS_{CE}

Where ITBS_{UE} is the UE's ITBS and ITBS_{CE} is the threshold ITBS which we shall consider a UE with lower than such threshold, a cell-edge UE. Where ITBS is not available, another transport block size indicator could be used as alternatives. Further information about ITBS and other suitable indicators can be found in 3GPP TS 36.213, hereby incorporated by reference.

Each UE shall be examined before each UL scheduling and the UE's status shall be updated.

Second, a particular cell-edge priority segment shall be chosen for each cell where cell-edge UE's UL allocations shall be prioritized to be made in such segment. The cell-edge segment shall be denoted by a starting sub-band (SB) index and an end SB index, where SB is defined as a group of resource blocks (RBs), determined as follows,

$${SB}_{start} = ⌊ \frac{PCI \% NumSeg}{NumSeg} * {Max}_{SBs} ⌋$$

if (PCI+1)=0,SB_{end}=Max_{SBs},

$$else , {SB}_{end} = ⌊ \frac{( PCI + 1 ) \% NumSeg}{NumSeg} * {Max}_{SBs} ⌋$$

Where SBₛₜₐᵣₜ, SB_{end} is the UL PUSCH allocation starting/ending sub-band, NumSeg is the system-default number of segments, and Max_{SBs} is the maximum number of sub-bands for PUSCH in the system. Basically, for each cell, we are using the Physical Cell Identifier (PCI) which uniquely identifies a cell as a distinct input variable in order to calculate a different allocation index where each cell shall prioritize its UL allocation cell-edge UEs. This improves the reliability for a cell-edge UE of decoding the PUSCH allocation, since a given cell's cell edge priority segment is non-overlapping with the cell edge priority segment of another cell. In operation, a UE at the cell edge between cell A and cell B will be able to receive the UL PUSCH allocation for either cell A or cell B without experiencing interference caused by the other cell in the same sub-bands.

As this is a best-effort solution, we shall try to allocate a cell-edge UE in the calculated segment and a cell-center UE in any other segment, however, if not possible, UEs shall be allocated wherever they can be allocated.

FIG. 1B shows this process in flowchart form.

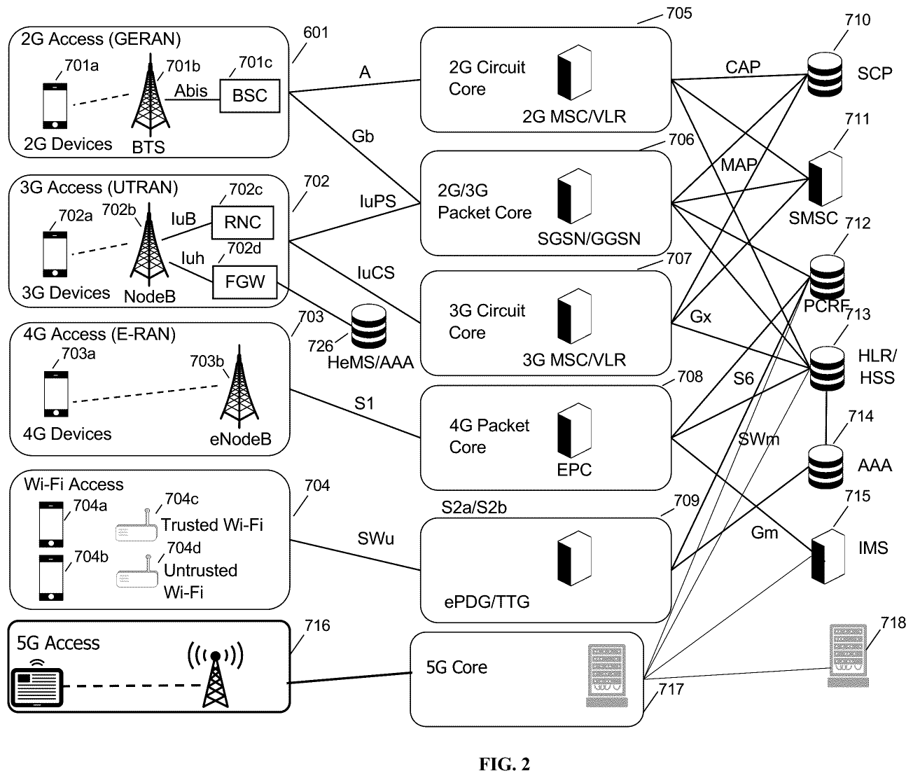

FIG. 2 is a schematic network architecture diagram for 3G and other-G prior art networks, in accordance with some embodiments. The diagram shows a plurality of “Gs,” including 2G, 3G, 4G, 5G and Wi-Fi. 2G is represented by GERAN 201, which includes a 2G device 201a, BTS 201b, and BSC 201c. 3G is represented by UTRAN 202, which includes a 3G UE 202a, nodeB 202b, RNC 202c, and femto gateway (FGW, which in 3GPP namespace is also known as a Home nodeB Gateway or HNBGW) 202d. 4G is represented by EUTRAN or E-RAN 203, which includes an LTE UE 203a and LTE eNodeB 203b. Wi-Fi is represented by Wi-Fi access network 204, which includes a trusted Wi-Fi access point 204c and an untrusted Wi-Fi access point 204d. The Wi-Fi devices 204a and 204b may access either AP 204c or 204d. In the current network architecture, each “G” has a core network. 2G circuit core network 205 includes a 2G MSC/VLR; 2G/3G packet core network 206 includes an SGSN/GGSN (for EDGE or UMTS packet traffic); 3G circuit core 207 includes a 3G MSC/VLR; 4G circuit core 208 includes an evolved packet core (EPC); and in some embodiments the Wi-Fi access network may be connected via an ePDG/TTG using S2a/S2b. Each of these nodes are connected via a number of different protocols and interfaces, as shown, to other, non-“G”-specific network nodes, such as the SCP 230, the SMSC 231, PCRF 232, HLR/HSS 233, Authentication, Authorization, and Accounting server (AAA) 234, and IP Multimedia Subsystem (IMS) 235. An HeMS/AAA 236 is present in some cases for use by the 3G UTRAN. The diagram is used to indicate schematically the basic functions of each network as known to one of skill in the art, and is not intended to be exhaustive. For example, 5G core 217 is shown using a single interface to 5G access 216, although in some cases 5G access can be supported using dual connectivity or via a non-standalone deployment architecture.

Noteworthy is that the RANs 201, 202, 203, 204 and 236 rely on specialized core networks 205, 206, 207, 208, 209, 237 but share essential management databases 230, 231, 232, 233, 234, 235, 238. More specifically, for the 2G GERAN, a BSC 201c is required for Abis compatibility with BTS 201b, while for the 3G UTRAN, an RNC 202c is required for Iub compatibility and an FGW 202d is required for Iuh compatibility. These core network functions are separate because each RAT uses different methods and techniques. On the right side of the diagram are disparate functions that are shared by each of the separate RAT core networks. These shared functions include, e.g., PCRF policy functions, AAA authentication functions, and the like. Letters on the lines indicate well-defined interfaces and protocols for communication between the identified nodes.

The system may include 5G equipment. 5G networks are digital cellular networks, in which the service area covered by providers is divided into a collection of small geographical areas called cells. Analog signals representing sounds and images are digitized in the phone, converted by an analog to digital converter and transmitted as a stream of bits. All the 5G wireless devices in a cell communicate by radio waves with a local antenna array and low power automated transceiver (transmitter and receiver) in the cell, over frequency channels assigned by the transceiver from a common pool of frequencies, which are reused in geographically separated cells. The local antennas are connected with the telephone network and the Internet by a high bandwidth optical fiber or wireless backhaul connection.

5G uses millimeter waves which have shorter range than microwaves, therefore the cells are limited to smaller size. Millimeter wave antennas are smaller than the large antennas used in previous cellular networks. They are only a few inches (several centimeters) long. Another technique used for increasing the data rate is massive MIMO (multiple-input multiple-output). Each cell will have multiple antennas communicating with the wireless device, received by multiple antennas in the device, thus multiple bitstreams of data will be transmitted simultaneously, in parallel. In a technique called beamforming the base station computer will continuously calculate the best route for radio waves to reach each wireless device, and will organize multiple antennas to work together as phased arrays to create beams of millimeter waves to reach the device.

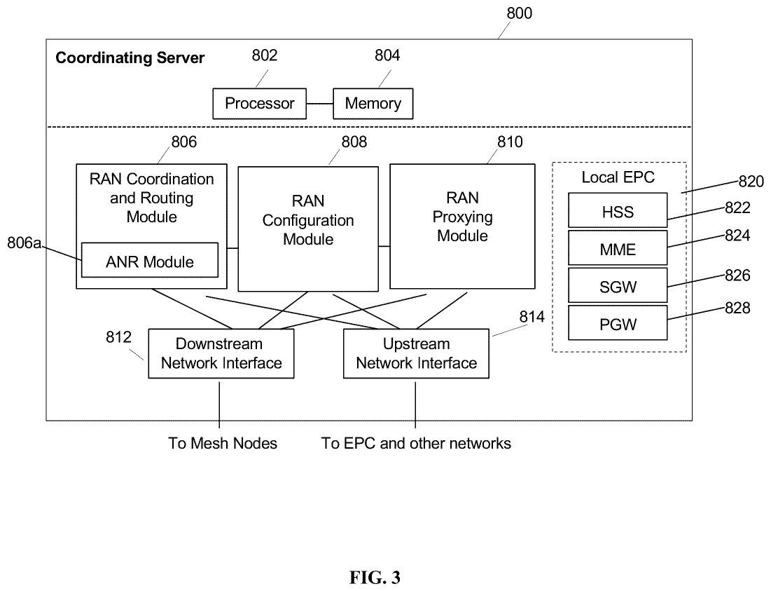

FIG. 3 is an enhanced eNodeB for performing the methods described herein, in accordance with some embodiments. While a particular eNodeB architecture is shown, other eNodeB architectures as known in the art are also suitable for practicing the invention. eNodeB 300 may include processor 302, processor memory 304 in communication with the processor, baseband processor 306, and baseband processor memory 308 in communication with the baseband processor. Mesh network node 300 may also include first radio transceiver 312 and second radio transceiver 314, internal universal serial bus (USB) port 316, and subscriber information module card (SIM card) 318 coupled to USB port 316. In some embodiments, the second radio transceiver 314 itself may be coupled to USB port 316, and communications from the baseband processor may be passed through USB port 316. The second radio transceiver may be used for wirelessly backhauling eNodeB 300.

Processor 302 and baseband processor 306 are in communication with one another. Processor 302 may perform routing functions, and may determine if/when a switch in network configuration is needed. Baseband processor 306 may generate and receive radio signals for both radio transceivers 312 and 314, based on instructions from processor 302. In some embodiments, processors 302 and 306 may be on the same physical logic board. In other embodiments, they may be on separate logic boards.

Processor 302 may identify the appropriate network configuration, and may perform routing of packets from one network interface to another accordingly. Processor 302 may use memory 304, in particular to store a routing table to be used for routing packets. Baseband processor 306 may perform operations to generate the radio frequency signals for transmission or retransmission by both transceivers 310 and 312. Baseband processor 306 may also perform operations to decode signals received by transceivers 312 and 314. Baseband processor 306 may use memory 308 to perform these tasks.

The first radio transceiver 312 may be a radio transceiver capable of providing LTE eNodeB functionality, and may be capable of higher power and multi-channel OFDMA. The second radio transceiver 314 may be a radio transceiver capable of providing LTE UE functionality. Both transceivers 312 and 314 may be capable of receiving and transmitting on one or more LTE bands. In some embodiments, either or both of transceivers 312 and 314 may be capable of providing both LTE eNodeB and LTE UE functionality. Transceiver 312 may be coupled to processor 302 via a Peripheral Component Interconnect-Express (PCI-E) bus, and/or via a daughtercard. As transceiver 314 is for providing LTE UE functionality, in effect emulating a user equipment, it may be connected via the same or different PCI-E bus, or by a USB bus, and may also be coupled to SIM card 318. First transceiver 312 may be coupled to first radio frequency (RF) chain (filter, amplifier, antenna) 322, and second transceiver 314 may be coupled to second RF chain (filter, amplifier, antenna) 324.

SIM card 318 may provide information required for authenticating the simulated UE to the evolved packet core (EPC). When no access to an operator EPC is available, a local EPC may be used, or another local EPC on the network may be used. This information may be stored within the SIM card, and may include one or more of an international mobile equipment identity (IMEI), international mobile subscriber identity (IMSI), or other parameter needed to identify a UE. Special parameters may also be stored in the SIM card or provided by the processor during processing to identify to a target eNodeB that device 300 is not an ordinary UE but instead is a special UE for providing backhaul to device 300.

Wired backhaul or wireless backhaul may be used. Wired backhaul may be an Ethernet-based backhaul (including Gigabit Ethernet), or a fiber-optic backhaul connection, or a cable-based backhaul connection, in some embodiments. Additionally, wireless backhaul may be provided in addition to wireless transceivers 312 and 314, which may be Wi-Fi 802.11a/b/g/n/ac/ad/ah, Bluetooth, ZigBee, microwave (including line-of-sight microwave), or another wireless backhaul connection. Any of the wired and wireless connections described herein may be used flexibly for either access (providing a network connection to UEs) or backhaul (providing a mesh link or providing a link to a gateway or core network), according to identified network conditions and needs, and may be under the control of processor 302 for reconfiguration.

A GPS module 330 may also be included, and may be in communication with a GPS antenna 332 for providing GPS coordinates, as described herein. When mounted in a vehicle, the GPS antenna may be located on the exterior of the vehicle pointing upward, for receiving signals from overhead without being blocked by the bulk of the vehicle or the skin of the vehicle. Automatic neighbor relations (ANR) module 332 may also be present and may run on processor 302 or on another processor, or may be located within another device, according to the methods and procedures described herein.

Other elements and/or modules may also be included, such as a home eNodeB, a local gateway (LGW), a self-organizing network (SON) module, or another module. Additional radio amplifiers, radio transceivers and/or wired network connections may also be included.

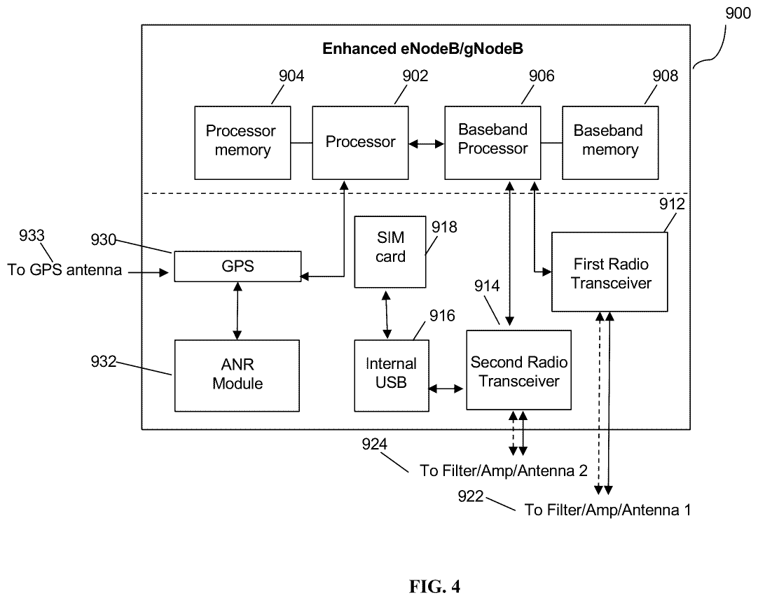

FIG. 4 is a coordinating server for providing services and performing methods as described herein, in accordance with some embodiments. Coordinating server 400 includes processor 402 and memory 404, which are configured to provide the functions described herein. Also present are radio access network coordination/routing (RAN Coordination and routing) module 406, including ANR module 406a, RAN configuration module 408, and RAN proxying module 410. The ANR module 406a may perform the ANR tracking, PCI disambiguation, ECGI requesting, and GPS coalescing and tracking as described herein, in coordination with RAN coordination module 406 (e.g., for requesting ECGIs, etc.). In some embodiments, coordinating server 400 may coordinate multiple RANs using coordination module 406. In some embodiments, coordination server may also provide proxying, routing virtualization and RAN virtualization, via modules 410 and 408. In some embodiments, a downstream network interface 412 is provided for interfacing with the RANs, which may be a radio interface (e.g., LTE), and an upstream network interface 414 is provided for interfacing with the core network, which may be either a radio interface (e.g., LTE) or a wired interface (e.g., Ethernet).

Coordinator 400 includes local evolved packet core (EPC) module 420, for authenticating users, storing and caching priority profile information, and performing other EPC-dependent functions when no backhaul link is available. Local EPC 420 may include local HSS 422, local MME 424, local SGW 426, and local PGW 428, as well as other modules. Local EPC 420 may incorporate these modules as software modules, processes, or containers. Local EPC 420 may alternatively incorporate these modules as a small number of monolithic software processes. Modules 406, 408, 410 and local EPC 420 may each run on processor 402 or on another processor, or may be located within another device.

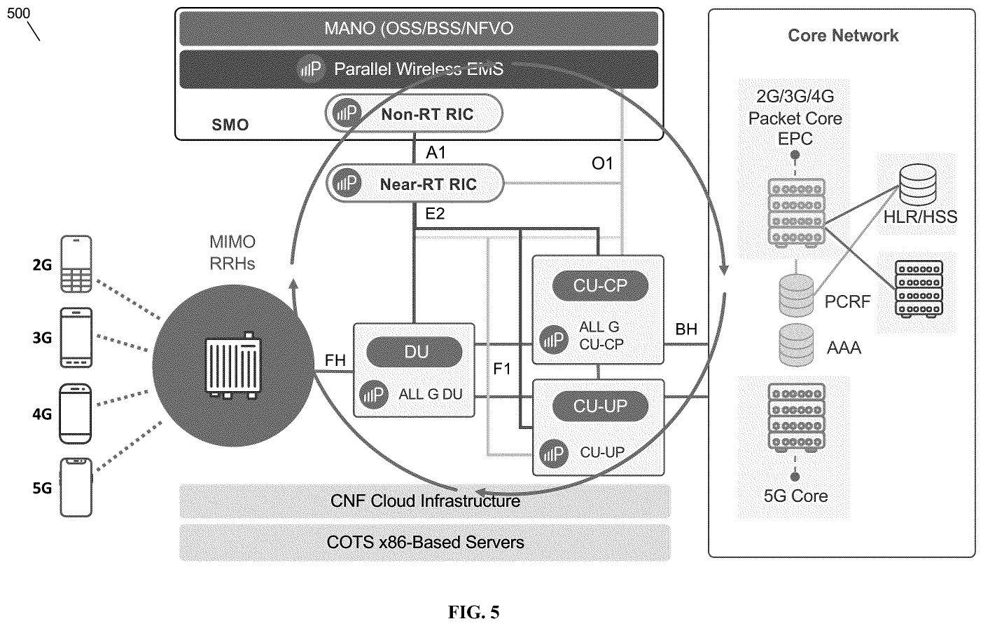

FIG. 5 is a schematic diagram of another, multi-RAT OpenRAN-compliant deployment architecture, in accordance with some embodiments. Multiple generations of UE are shown, connecting to RRHs that are coupled via fronthaul to an all-G Parallel Wireless DU. The all-G DU is capable of interoperating with an all-G CU-CP and an all-G CU-UP. Backhaul may connect to the operator core network, in some embodiments, which may include a 2G/3G/4G packet core, EPC, HLR/HSS, PCRF, AAA, etc., and/or a 5G core. In some embodiments an all-G near-RT RIC is coupled to the all-G DU and all-G CU-UP and all-G CU-CP. Unlike in the prior art, the near-RT RIC is capable of interoperating with not just 5G but also 2G/3G/4G.

The all-G near-RT RIC may perform processing and network adjustments that are appropriate given the RAT. For example, a 4G/5G near-RT RIC performs network adjustments that are intended to operate in the 100 ms latency window. However, for 2G or 3G, these windows may be extended. As well, the all-G near-RT RIC can perform configuration changes that takes into account different network conditions across multiple RATs. For example, if 4G is becoming crowded or if compute is becoming unavailable, admission control, load shedding, or UE RAT reselection may be performed to redirect 4G voice users to use 2G instead of 4G, thereby maintaining performance for users. As well, the non-RT RIC is also changed to be a near-RT RIC, such that the all-G non-RT RIC is capable of performing network adjustments and configuration changes for individual RATs or across RATs similar to the all-G near-RT RIC. In some embodiments, each RAT can be supported using processes, that may be deployed in threads, containers, virtual machines, etc., and that are dedicated to that specific RAT, and, multiple RATs may be supported by combining them on a single architecture or (physical or virtual) machine. In some embodiments, the interfaces between different RAT processes may be standardized such that different RATs can be coordinated with each other, which may involve interworking processes or which may involve supporting a subset of available commands for a RAT, in some embodiments.

In any of the scenarios described herein, where processing may be performed at the cell, the processing may also be performed at or in coordination with a cloud coordination server, a DU, a CU, and/or a near-RT RIC. A mesh node may be an eNodeB or multi-RAT BS. An eNodeB may be in communication with the cloud coordination server via an X2 protocol connection, or another connection. The eNodeB may perform inter-cell coordination via the cloud communication server when other cells are in communication with the cloud coordination server. The eNodeB may communicate with the cloud coordination server to determine whether the UE has the ability to support a handover to Wi-Fi, e.g., in a heterogeneous network.

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders, as necessary.

Although the above systems and methods for providing interference mitigation are described in reference to the Long Term Evolution (LTE) standard, one of skill in the art would understand that these systems and methods could be adapted for use with other wireless standards or versions thereof. The inventors have understood and appreciated that the present disclosure could be used in conjunction with various network architectures and technologies. Wherever a 4G technology is described, the inventors have understood that other RATs have similar equivalents, such as a gNodeB for 5G equivalent of eNB. For example, where 4G PCI is specified, 5G also uses PCI, and, where 4G PCI is used as an input to distinguish cell edge priority segments, a 5G PCI could be used and vice versa. Wherever an MME is described, the MME could be a 3G RNC or a 5G AMF/SMF. Additionally, wherever an MME is described, any other node in the core network could be managed in much the same way or in an equivalent or analogous way, for example, multiple connections to 4G EPC PGWs or SGWs, or any other node for any other RAT, could be periodically evaluated for health and otherwise monitored, and the other aspects of the present disclosure could be made to apply, in a way that would be understood by one having skill in the art.

Additionally, the inventors have understood and appreciated that it is advantageous to perform certain functions at a coordination server, such as the Parallel Wireless HetNet Gateway, which performs virtualization of the RAN towards the core and vice versa, so that the core functions may be statefully proxied through the coordination server to enable the RAN to have reduced complexity. Therefore, at least four scenarios are described: (1) the selection of an MME or core node at the base station; (2) the selection of an MME or core node at a coordinating server such as a virtual radio network controller gateway (VRNCGW); (3) the selection of an MME or core node at the base station that is connected to a 5G-capable core network (either a 5G core network in a 5G standalone configuration, or a 4G core network in 5G non-standalone configuration); (4) the selection of an MME or core node at a coordinating server that is connected to a 5G-capable core network (either 5G SA or NSA). In some embodiments, the core network RAT is obscured or virtualized towards the RAN such that the coordination server and not the base station is performing the functions described herein, e.g., the health management functions, to ensure that the RAN is always connected to an appropriate core network node. Different protocols other than S1AP, or the same protocol, could be used, in some embodiments.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols, or other air interfaces.

In some embodiments, the software needed for implementing the methods and procedures described herein may be implemented in a high level procedural or an object-oriented language such as C, C++, C#, Python, Java, or Perl. The software may also be implemented in assembly language if desired. Packet processing implemented in a network device can include any processing determined by the context. For example, packet processing may involve high-level data link control (HDLC) framing, header compression, and/or encryption. In some embodiments, software that, when executed, causes a device to perform the methods described herein may be stored on a computer-readable medium such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 microprocessor.

In some embodiments, the radio transceivers described herein may be base stations compatible with a Long Term Evolution (LTE) radio transmission protocol or air interface. The LTE-compatible base stations may be eNodeBs. In addition to supporting the LTE protocol, the base stations may also support other air interfaces, such as UMTS/HSPA, CDMA/CDMA2000, GSM/EDGE, GPRS, EVDO, 2G, 3G, 5G, TDD, or other air interfaces used for mobile telephony.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols, or other air interfaces.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to LTE-compatible networks, to UMTS-compatible networks, or to networks for additional protocols that utilize radio frequency data transmission. Various components in the devices described herein may be added, removed, split across different devices, combined onto a single device, or substituted with those having the same or similar functionality.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment.

1. A method of Uplink (UL) Fractional Frequency Reuse (FFR), comprising:
classifying a User Equipment (UE) as either a cell-edge UE or a cell-center UE;
examining each UE before each UL scheduling and updating a status of the UE that was examined; and
choosing a cell-edge segment for each cell, a cell-edge segment including a starting SB index and an ending SB index, wherein an SB is a group of Resource Blocks (RBs).
